(19) United States
(12) Patent Application Publication
(10) Pub. No.: US 2007/0047596 A1
(43) Pub. Date: Mar. 1, 2007

(54) Photonic band-gap fiber based mode locked fiber laser at one micron

(75) Inventor: Jian Liu, Sunnyvale, CA (US)

Correspondence Address: Bo-In Lin, 13445 Mandoli Drive, Los Altos, CA, 94022, US

(73) Assignee: PolarOnyx, Inc.

(21) Appl. No.: 11/512,895

(22) Filed: Aug. 29, 2006

Related U.S. Application Data
(60) Provisional application No. 60/713,650, filed on Aug. 29, 2005.
(60) Provisional application No. 60/713,653, filed on Aug. 29, 2005.
(60) Provisional application No. 60/713,654, filed on Aug. 29, 2005.
(60) Provisional application No. 60/714,468, filed on Sep. 1, 2005.
(60) Provisional application No. 60/714,570, filed on Sep. 7, 2005.

(51) Int. Cl. H01S 3/30; H01S 3/098

(52) U.S. Cl. 372/6; 372/18

(57) ABSTRACT

A fiber laser cavity that includes a laser gain medium for receiving an optical input projection from a laser pump. The fiber laser cavity further includes a positive dispersion fiber segment and a negative dispersion fiber segment for generating a net negative dispersion for balancing a self-phase modulation (SPM) and a dispersion induced pulse broadening/compression in the fiber laser cavity for generating an output laser with a transform-limited pulse shape wherein the laser gain medium further amplifying and compacting a laser pulse. The gain medium further includes a Ytterbium doped fiber for amplifying and compacting a laser pulse. The fiber laser cavity further includes a polarization sensitive isolator and a polarization controller for further shaping the output laser.

This Formal Application claims a Priority Date of Aug. 29, 2005 benefited from a Provisional Patent Application 60/713,650, 60/713,653, and 60/713,654 and a Priority Date of Sep. 1, 2005 benefited from Provisional Application 60/714,468 and 60/714,570 filed by one of the same Applicants of this Application.

### FIELD OF THE INVENTION

The present invention relates generally to apparatuses and methods for providing short-pulsed mode-locked fiber laser. More particularly, this invention relates to new configurations and methods for providing a photonic band-gap fiber based mode-locked fiber laser

### BACKGROUND OF THE INVENTION

Due to the nature of fiber materials, conventional silica fibers cannot generate negative dispersions. Therefore, a conventional fiber laser system configured by using the silica optical fibers must implement grating lens or prism pairs to generate negative dispersions. It is necessary to generate a negative dispersion in a fiber laser system for providing a short pulse mode-locked laser system that can generate output laser with ultra-short pulse and high laser power. The negative dispersions are necessary to overcome the technical difficulties caused by pulse shape distortions. Specifically, the practical usefulness of the ultra-short high power lasers are often hindered by the pulse shapes distortions as will be further explained and discussed below. Furthermore, when grating lens or prism pairs are implemented to correct the pulse shape distortions, such laser systems are often bulky, difficult for alignment maintenance, and also lack sufficient robustness. All these difficulties prevent practical applications of the ultra-short high power lasers. The following explanations are background information to better understand the why there is an urgent for providing the improved laser systems of this invention.

Historically, generation of mode-locked laser with the pulse width down to a femtosecond level is a difficult task due to limited resources of saturation absorbers and anomalous dispersions of fibers. Conventionally, short pulse mode locked fiber lasers operated at wavelengths below 1.3 μm present a particular challenge is that there is no simple all fiber based solution for dispersion compensation in this wavelength regime. (For wavelengths above 1.3 μm, several types of fibers exist exhibiting either normal or anomalous dispersion, so by splicing different lengths of fibers together one can obtain a cavity with an adjustable dispersion.) Therefore, previous researchers use bulk devices, such as grating pairs and prisms to provide an adjustable amount of dispersion for the cavity. Unfortunately these devices require the coupling of the fiber into a bulk device, which results in a laser that is highly sensitive to alignment and thus the environment

Several conventional techniques disclosed different semiconductor saturation absorbers to configure the ultra-short high power laser systems. However, such configurations often developed into bulky and less robust systems due to the implementations of free space optics. Such systems have been disclosed by S. N. Bagayev, S. V. Chepurov, V. M. Klementyev, S. A. Kuznetsov, V. S. Pivtsov, V. V. Pokasov, V. F. Zakharyash, A femtosecond self-mode-locked Ti:sapphire laser with high stability of pulserepetition frequency and its applications (Appl. Phys. B, 70, 375-378 (2000).), and Jones D. J., Diddams S. A., Ranka J. K., Stentz A., Windeler R. S., Hall J. L., Cundi® S. T., Carrierenvelope phase control of femtosecond mode-locked laser and direct optical frequency synthesis. (Science, vol. 288, pp. 635-639, 2000.). 70, 375-378 (2000).).

Subsequently, the stretched mode-locked fiber lasers are disclosed to further improve the generation of the short pulse high power lasers. However, even in the stretched mode locked fiber lasers, the free space optic components such as quarter wave retarder and splitters for collimating and coupling are implemented. Examples of these systems are described by John L. Hall, Jun Ye, Scott A. Diddams, Long-Sheng Ma, Steven T. Cundi®, and David J. Jones, in “Ultrasensitive Spectroscopy, the Ultrastable Lasers, the Ultrafast Lasers, and the Seriously Nonlinear Fiber: A New Alliance for Physics and Metrology” (IEEE JOURNAL OF QUANTUM ELECTRONICS, VOL. 37, NO. 12, DECEMBER 2001), and also by L. Hollberg, C. W. Oates, E. A. Curtis, E. N. Ivanov, S. A. Diddams, Th. Udem, H. G. Robinson, J. C. Bergquist, R. J. Rafac, W. M. Itano, R. E. Drullinger, and D. J. Wineland, in “Optical frequency standards and measurements” IEEE J. Quant. Electon. 37, 1502 (2001).

The limitations for practical application of such laser systems are even more pronounced due the pulse shape distortions when the pulse width is further reduced compounded with the requirement of high power fiber amplification. When the pulse width narrows down to femtosecond level and the peak power increases to over 10 kW, strong nonlinear effects such as self phase modulation (SPM) and XPM will cause more serious spectral and temporal broadening. These nonlinear effects and spectral and temporal broadening further causes a greater degree of distortions to the laser pulses. The technical difficulties cannot be easily resolved even though a large mode area (LMA) fiber can be used to reduce SBS and SRS to increase saturation power. However, the large mode area fiber when implemented will in turn cause a suppression of the peak power and leads to an undesirable results due to the reduction of the efficiency

There is an urgent demand to resolve these technical difficulties as the broader applications and usefulness of the short pulse mode-locked are demonstrated for measurement of ultra-fast phenomena, micro machining, and biomedical applications. Different techniques are disclosed in attempt to resolve such difficulties. Such techniques include the applications of nonlinear polarization rotation (NLPR) or stretched mode locked fiber lasers as discussed above. As the NLPR deals with the time domain intensity dependent polarization rotation, the pulse shape distortions cannot be prevented due to the polarization evolution in both the time domain and the spectral domain. For these reasons, the conventional technologies do not provide an effective system configuration and method to provide effective ultra-short pulse high power laser systems for generating high power laser pulses with acceptable pulse shapes.

In addition to the above described difficulties, these laser systems require grating pairs for dispersion control in the laser cavity. Maintenance of alignment in such systems becomes a time consuming task thus prohibiting a system implemented with free space optics and grating pairs from practical applications. Also, the grating pairs further add to the size and weight of the laser devices and hinder the effort to miniaturize the devices implemented with such laser sources.

In order to overcome such difficulties, the Applicant of the present invention discloses a fiber laser cavity in two prior patent application Ser. Nos. 11/093,519 and 11/136,040. The disclosures made in these two prior Patent Applications are hereby incorporated by reference. A fiber laser cavity is included in these two Applications that includes a laser gain medium for receiving an optical input projection from a laser pump. The fiber laser cavity further includes a positive dispersion fiber segment and a negative dispersion fiber segment for generating a net negative dispersion for balancing a self-phase modulation (SPM) and a dispersion induced pulse broadening-compression in the fiber laser cavity for generating an output laser with a transform-limited pulse shape.

However, since the conventional silica fibers cannot provide the required negative dispersions as that disclosed in these improved systems, a new and improved fiber that can generate negative dispersion is still required to overcome the above discussed difficulties and limitations. Therefore, a need still exists in the art of fiber laser design and manufacture to provide a new and improved laser system with new fibers to provide ultra-short high power mode-locked fiber laser with better controllable pulse shapes such that the above discussed difficulty may be resolved.

### SUMMARY OF THE PRESENT INVENTION

It is therefore an aspect of the present invention to provide a method of generating a negative dispersion by using a photonic band-gap fiber (PBF) segment to balance a self-phase modulation (SPM) and a dispersion induced pulse broadening-compression in a fiber laser cavity.

Another aspect of this invention is to provide a design to achieve all fiber solution for 1 μm mode locked fiber laser by overcoming a difficulty that the nature of conventional fiber made by silica fiber material is not feasible to generate a negative. The self-phase modulation (SPM) and a dispersion induced pulse broadening-compression have to be compensated by grating pairs or prisms. The difficulty is resolved by using a Photonic bandgap fiber (PBF) as an improved fiber for manipulating and generating a negative dispersion for compensating and canceling the effects of self-phase modulation (SPM) and dispersion induced pulse broadening-compression.

Another aspect of this invention is to provide a mode locked fiber laser cavity with a piece of YDF for amplification and a WDM coupler for combining 980 nm pump and 1 micron signal. The mode-locked fiber further implements a polarization beam splitter, a semiconductor saturation absorber (SESAM), and a piece of PBF for negative dispersion compensation.

Another aspect of this invention is to provide a mode-locked fiber laser cavity with a polarization controller disposed in front of the polarization beam splitter in adjusting the output coupling-ratio. Furthermore, a mirror is put on one end-face of the PBF to reflect the signal back into the cavity.

Another aspect of this invention is to provide a mode-locked fiber laser cavity with the PBF that for transmitting a laser projection with birefringence and with the polarization axis of the slow axis of one PM fiber port of the polarization beam splitter lined up with that of the PBF. The mode-locked fiber laser cavity further utilizes the SESAM to enhance a self-start in the mode-locked fiber laser cavity.

Briefly, in a preferred embodiment, the present invention discloses a fiber laser cavity comprising a laser gain medium for receiving an optical input projection from a laser pump. The fiber laser cavity further includes a photonic band gap fiber (PBF) segment for generating a negative dispersion for balancing a self-phase modulation (SPM) and a dispersion induced pulse broadening-compression in the fiber laser cavity. The gain medium further comprising a Ytterbium doped fiber (YDF) for amplifying a laser pulse. The laser cavity further includes a wavelength division multiplexing device for coupling to the laser pump for receiving the optical input projection and a semiconductor saturation absorber (SESAM) to enhance a self-start operation of the fiber laser cavity by performing a function of intensity dependent transmittance. In a preferred embodiment, the laser cavity further includes a mirror disposed an end-face of the PBF to reflect a laser projection back into the fiber laser cavity and a polarization beam splitter for transmitting an output laser. In another preferred embodiment, the laser cavity further includes a polarization controller disposed between the gain medium and the polarization beam splitter for adjusting an output coupling ratio. In a preferred embodiment, the fiber laser cavity constituting a mode-locked fiber laser cavity. In another preferred embodiment, the PBF transmitting an optical signal with a birefringence and the PBF having a slow polarization axis lined up with a polarization beam splitter for transmitting an output laser from the polarization beam splitter. In another preferred embodiment, the fiber laser cavity constituting an all fiber 1 μm mode-locked fiber laser cavity.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is functional block diagram for a short-pulse mode-locked fiber laser of this invention.

FIG. 2 is a cross sectional view of an air core Photonics band gap fiber.

### DETAILED DESCRIPTION OF THE INVENTION

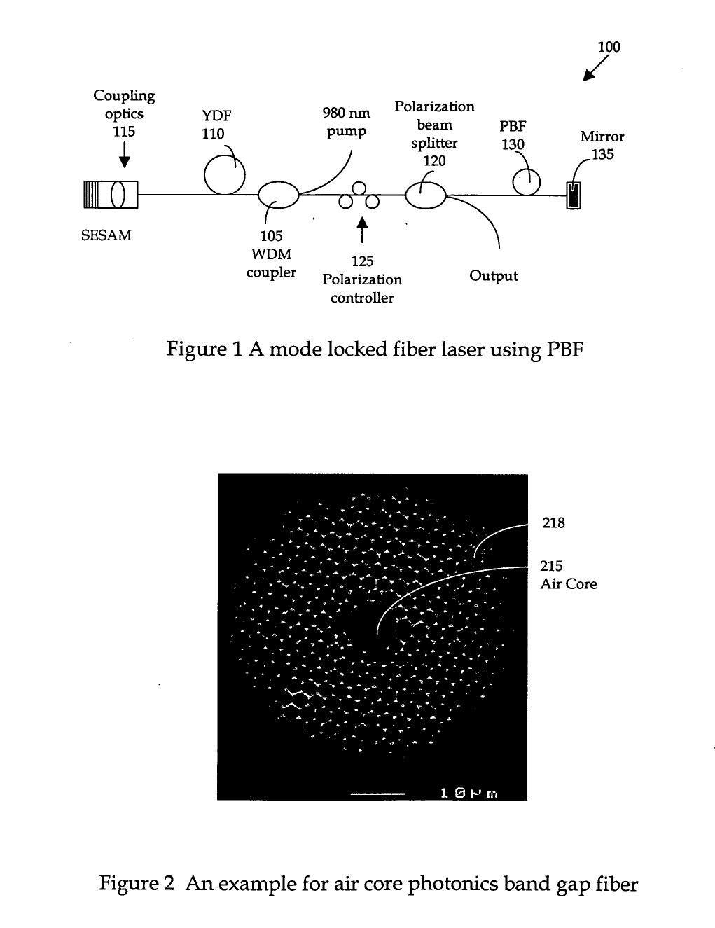

Referring to FIG. 1 for a schematic diagram of a nonlinear polarization pulse-shaping mode locked fiber laser 100 of this invention. The fiber laser system includes wavelength division multiplexing (WMD) coupler 105 to receive a laser input from a 980 nm pump for combining with a one micron signal to project to a gain medium Ytterbium (Yb) doped fiber (YDF) 110. An amplified laser signal is transmitted to a semiconductor saturation absorber (SESAM) 115 and to a polarization beam splitter 120 via a polarization controller 125. The polarization controller 125 is placed in front of the polarization beam splitter 120 for adjusting of the output coupling-ratio. The fiber laser system further includes a photonic band-gap fiber (PBF) 130 that includes a mirror 135 placed on one end-face of the PBF 130 to reflect the signal back into the cavity. The photonic band-gap fiber (PBF) 130 is a newly available fiber which dispersion can be manipulated to negative dispersion. The function of the PBF and the manipulation of the negative dispersion will be further discussed below. Due to birefringence of the PBF 130, the polarization axis of the slow axis of one Polarization mode (PM) fiber port of the polarization beam splitter has to be lined up with that of the PBF. A slow axis is one of the polarization eigen vectors. Along this axis, the polarization will not change along propagation. The benefit of this arrangement is to assure that there is no polarization mixing and maintain single polarization propagation. The SESAM used in the cavity is to help the mode locked fiber laser self-start. The SESAM has an intensity dependent transmittance while transmitting the strong portion of the pulse and block the weak portion of the pulse. This helps the pulse build up while resonance in the cavity.

A pulse propagate in the cavity experience both positive (YDF and other conventional fibers (pigtails of components) and negative dispersion fiber PBF. Due to the dispersion variation, the pulse width will be narrowed and broadened in these fibers dependent on its chirping characteristics. When the pulse goes through SESAM, the peak portion of the pulse will be transmitted and then reflected back to the cavity while the weak portion be blocked. This will make the pulse narrowing to make the pulses build-up in the cavity with same properties and force the same pulses to start locking in phase and stay in a stable operation. Further details are disclosed in patent application Ser. Nos. 11/093,519 and 11/136,040 and the disclosures made in these Applications are hereby incorporated by reference in this Patent Application.

To further improve the performance of dispersion control, a special fiber is implemented by manipulating the filling factor of the air holes as that disclosed by V. Reichel, et al., in “Applications of pump multiplexed Yb-doped fiber lasers,” SPIE 4974, 148 (2003). FIG. 2 shows the structure that is made by stacking silica capillaries 218 into a hexagonal close packed structure and replacing a capillary at the center of the stack with a solid silica rod 215 to form a solid fiber core. The air core will be formed in a similar way thus form a fiber generally known as photonic band gap-PBG fiber. As the fibers of solid core have a positive dispersion at 1 micron wavelength the PBF fiber can have negative dispersion by manipulating its hollow hole size and structures thus achieve the purpose of this invention.

According to above descriptions and disclosures made in the drawings, this invention further discloses a method for generating an output laser from a laser cavity includes a laser gain medium. The method includes a step of utilizing a photonic band gap filter (PBF) segment in the laser cavity for generating a negative dispersion for balancing a self-phase modulation (SPM) and a dispersion induced pulse broadening-compression. In a preferred embodiment, the method further includes a step of utilizing a Ytterbium doped fiber (YDF) as the laser gain cavity for amplifying a laser pulse. In another preferred embodiment, the method further includes a step of utilizing a wavelength division multiplexing (WDM) device for coupling to the laser pump for receiving the optical input projection. In another preferred embodiment, the method further includes a step of utilizing a semiconductor saturation absorber (SESAM) to enhance a self-start operation of the fiber laser cavity by performing a function of intensity dependent transmittance. In another preferred embodiment, the method further includes a step of disposing a mirror on an end-face of the PBF to reflect a laser projection back into the fiber laser cavity In another preferred embodiment, the method further includes a step of transmitting an output laser through a polarization beam splitter. In another preferred embodiment, the method further includes a step of disposing a polarization controller between the gain medium and the polarization beam splitter for adjusting an output coupling-ratio. In another preferred embodiment, the method further includes a step of configuring the fiber laser cavity as a mode-locked fiber laser cavity. In another preferred embodiment, the step of utilizing the PBF further includes a step of utilizing the PBF for transmitting an optical signal with a birefringence and lining up a slow polarization axis of the PBF with a polarization beam splitter for transmitting an output laser from the polarization beam splitter. In another preferred embodiment, the method further includes a step of configuring the fiber laser cavity as an all fiber 1 μm mode-locked fiber laser cavity.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A fiber laser cavity comprising a laser gain medium for receiving an optical input projection from a laser pump, wherein said mode-locked fiber laser further comprising:
a photonic band gap fiber (PBF) segment for generating a negative dispersion for balancing a self-phase modulation (SPM) and a dispersion induced pulse broadening-compression in said fiber laser cavity.

2. The fiber laser cavity of claim 1 wherein:
said gain medium further comprising a Ytterbium doped fiber (YDF) for amplifying a laser pulse.

3. The fiber laser cavity of claim 1 further comprising:
a wavelength division multiplexing device for coupling to said laser pump for receiving said optical input projection.

4. The fiber laser cavity of claim 1 further comprising:
a semiconductor saturation absorber (SESAM) to enhance a self-start operation of the fiber laser cavity by performing a function of intensity dependent transmittance.

5. The fiber laser cavity of claim 1 further comprising:
a mirror disposed an end-face of the PBF to reflect a laser projection back into said fiber laser cavity

6. The fiber laser cavity of claim 1 further comprising:
a polarization beam splitter for transmitting an output laser.

7. The fiber laser cavity of claim 6 further comprising:
a polarization controller disposed between said gain medium and said polarization beam splitter for adjusting an output coupling ratio.

8. The fiber laser cavity of claim 1 wherein:
said fiber laser cavity constituting a mode-locked fiber laser cavity.

9. The fiber laser cavity of claim 1 wherein:
said PBF transmitting an optical signal with a birefringence and said PBF having a slow polarization axis lined up with a polarization beam splitter for transmitting an output laser from said polarization beam splitter.

10. The fiber laser cavity of claim 1 wherein:
said fiber laser cavity constituting an all fiber 1 μm mode-locked fiber laser cavity.

11. A method for generating an output laser from a laser cavity comprising a laser gain medium, the method comprising:
utilizing a photonic band gap filter (PBF) segment in said laser cavity for generating a negative dispersion for balancing a self-phase modulation (SPM) and a dispersion induced pulse broadening-compression.

12. The method of claim 11 wherein:
utilizing a Ytterbium doped fiber (YDF) as said laser gain cavity for amplifying a laser pulse.

13. The method of claim 11 further comprising:
utilizing a wavelength division multiplexing (WDM) device for coupling to said laser pump for receiving said optical input projection.

14. The method of claim 11 further comprising:
utilizing a semiconductor saturation absorber (SESAM) to enhance a self-start operation of the fiber laser cavity by performing a function of intensity dependent transmittance.

15. The method of claim 11 further comprising:
disposing a mirror on an end-face of the PBF to reflect a laser projection back into said fiber laser cavity

16. The method of claim 11 further comprising:
transmitting an output laser through a polarization beam splitter for.

17. The method of claim 16 further comprising:
disposing a polarization controller between said gain medium and said polarization beam splitter for adjusting an output coupling ratio.

18. The method of claim 11 further comprising a step of:
configuring said fiber laser cavity as a mode-locked fiber laser cavity.

19. The method of claim 11 wherein:
said step of utilizing said PBF further comprising a step of utilizing said PBF for transmitting an optical signal with a birefringence and lining up a slow polarization axis of said PBF with a polarization beam splitter for transmitting an output laser from said polarization beam splitter.

20. The method of claim 11 further comprising a step of:
configuring said fiber laser cavity as an all fiber 1 μm mode-locked fiber laser cavity.
